(19) United States
(12) Patent Application Publication
(10) Pub. No.: US 2021/0115668 A1
(43) Pub. Date: Apr. 22, 2021

(54) Solid Cement Construction Panel

(71) Applicants: Tony Ning LEE, NSW (AU); Florence Jiean LEE, NSW (AU)

(72) Inventors: Tony Ning LEE, NSW (AU); Florence Jiean LEE, NSW (AU)

(21) Appl. No.: 16/660,792

(22) Filed: Oct. 22, 2019

(51) Int. Cl. E04C 2/04; C04B 28/30; C04B 16/08; E04B 5/04; E04B 2/84; C04B 14/06; C04B 18/08

(52) U.S. Cl. CPC E04C 2/044; C04B 28/30; C04B 16/08; C04B 2111/00698; E04B 2/842; C04B 14/06; C04B 18/08; E04B 5/043

(57) ABSTRACT

A solid cement construction panel includes an interior core filling sandwiched between two exterior faces to form a composite panel. The interior core filling is constructed to have a high strength cement, EPS (expanded polystyrene) foam, fly ash, sand particles and water, wherein the interior core filling has properties of heat preservation and soundproof. Each of the exterior faces is made of fiber reinforced material having properties of light weight, heat insulation, fireproof, and waterproof and moisture-proof.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a construction panel, and more particularly to a solid cement construction panel, which is an eco-friendly product composed of an exterior face and an interior core filing to form a non-load bearing and light weight composite wall panel while being cost effective.

### Description of Related Arts

The use of gypsum drywall board in modern construction is well known. The drywall boards are pre-manufactured that the drywall boards are cut and nailed to studs to from interior walls and ceilings. One of the major advantage of the drywall board is that it is easy to install by simply nailing the drywall board to the studs. However, the drywall board has several drawbacks. As it is mentioned, the wood studs must be configured before the drywall boards are installed. In many buildings, wood studs cannot be used in the frame structure, such that drywall boards cannot be used to form the interior walls. The drywall board has relatively low durability, especially when subject to damage from impact or abrasion, and bad sound attenuation.

A concrete formwork panel is commonly used and is composed of a concrete core and a synthetic outer skin to solve the problems of the drywall boards. However, the synthetic outer skin is easy to deform especially due to the changes of ambient temperature. The expansion or contraction of the concrete core will create a concrete pressure to deform the synthetic outer skin.

### SUMMARY OF THE PRESENT INVENTION

The invention is advantageous in that it provides a solid cement construction panel and its manufacturing method thereof, which is an eco-friendly product composed of an exterior face and an interior core filing to form a non-load bearing and light weight composite wall panel while being cost effective.

Another advantage of the invention is to provide a solid cement construction panel and its manufacturing method thereof, wherein the interior core filling has properties of heat preservation and soundproof, while the exterior face has properties of light weight, heat insulation, fireproof, and waterproof and moisture-proof

Another advantage of the invention is to provide a solid cement construction panel and its manufacturing method thereof, wherein the solid cement construction panel is an energy efficient wall structure to effectively maintain an ambient temperature.

Another advantage of the invention is to provide a solid cement construction panel and its manufacturing method thereof, which is relatively simple in structure and high eco-efficiency to energy environmental energy.

Another advantage of the invention is to provide a solid cement construction panel and its manufacturing method thereof, wherein the solid cement construction panel can be incorporated with any existing wall structure to form an interior wall of a building.

Another advantage of the invention is to provide a solid cement construction panel and its manufacturing method thereof, wherein the manufacturing method is simple and rapid to integrally mold the interior core filling between the exterior faces.

Another advantage of the invention is to a gemstone purchasing system, wherein no expensive or complicated structure is required to employ in the present invention in order to achieve the above mentioned objects. Therefore, the present invention successfully provides an economic and efficient solution for providing a rigid wall structure with easy installation of the panels.

Additional advantages and features of the invention will become apparent from the description which follows, and may be realized by means of the instrumentalities and combinations particular point out in the appended claims.

According to the present invention, the foregoing and other objects and advantages are attained by a solid cement construction panel includes an interior core filling sandwiched between two exterior faces to form a composite panel. The interior core filling is constructed to have a high strength cement, EPS (expanded polystyrene) foam, fly ash, sand particles and water, wherein the interior core filling has properties of heat preservation and soundproof. Each of the exterior faces is made of fiber reinforced material having properties of light weight, heat insulation, fireproof, and waterproof and moisture-proof.

In accordance with another aspect of the invention, the present invention comprises a method of manufacturing a solid cement construction panel, comprising the following steps.

(A) Configure an interior core filling by high strength cement, EPS (expanded polystyrene) foam, fly ash, sand particles and water.

(B) Configure two exterior faces each being made of fiber reinforced material.

(C) Form a composite panel by sandwiching the interior core filling between the exterior faces.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a solid cement construction panel according to a preferred embodiment of the present invention.

FIG. 2 is a perspective view of the solid cement construction panel according to a preferred embodiment of the present invention, illustrating the solid cement construction panels are coupled side-by-side.

FIG. 3 is a flow diagram illustrating a manufacturing method of the solid cement construction panel according to a preferred embodiment of the present invention.

FIG. 4 is a block diagram illustrating the manufacturing method of the solid cement construction panel according to a preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

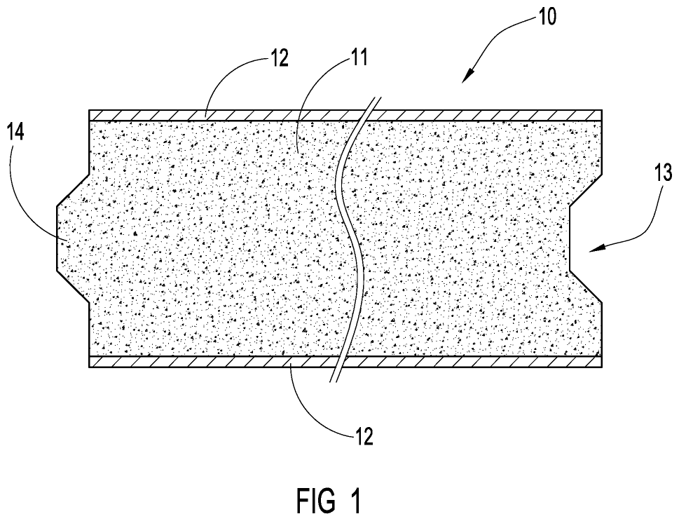

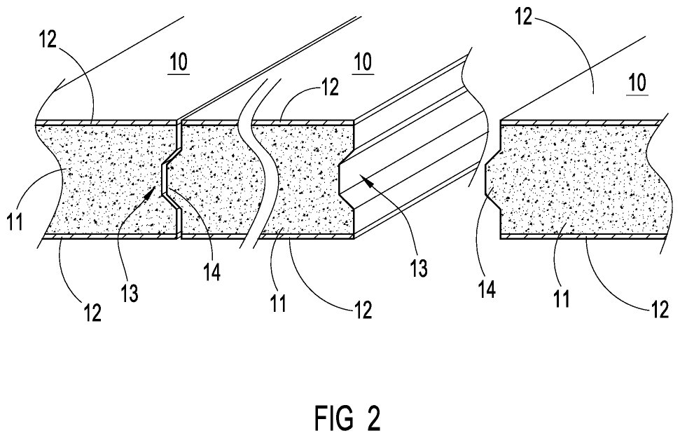

Referring to FIGS. 1 and 2 of the drawings, a formwork panel system according to a preferred embodiment is illustrated, wherein the formwork panel system comprises a plurality of solid cement construction panels 10. Each of the solid cement construction panels 10 comprises an interior core filling 11 sandwiched between two exterior faces 12 to form a composite panel. Preferably, the interior core filling 11 is integrally molded between the exterior faces 12 to form the composite panel.

The interior core filling 11 is constructed to have a high strength cement, EPS (expanded polystyrene) foam, fly ash, and water, wherein the interior core filling has properties of heat preservation and soundproof. Accordingly, the high strength cement has a compression strength not lower than 42.5 MPa.

In one example, the interior core filling 11 is constructed to further have a predetermined amount of magnesium oxysulfate cement, additive (such as AOE-9), sand particles and fine rock particles. Particularly, the interior core filling 11 is composed of 5-18% by weight of high strength cement, 11-25% by weight of EPS foam, 1-10% by weight of magnesium oxysulfate cement, 0.02-1% by weight of additive, 5-28% by weight of sand particles, 15-40% by weight of fine rock particles, 3-20% by weight of fly ash, and 10-25% by weight of water.

In another example, the interior core filling 11 is constructed to further have a predetermined amount of magnesium oxysulfate cement, additive (such as AOE-9), sand particles, fine rock particles, polycarboxylate superplasticizer, perlite concrete, and fiberglass. Particularly, the interior core filling 11 is composed of 3-15% by weight of high strength cement, 10-25% by weight of EPS foam, 3-20% by weight of magnesium oxysulfate cement, 0.02-0.1% by weight of additive, 3-20% by weight of sand particles, 3-18% by weight of fine rock particles, 8-10% by weight of fly ash, 15-16% by weight of water, 0.5-1% by weight of polycarboxylate superplasticizer, 10-30% by weight of perlite concrete, and 5-15% by weight of fiberglass.

In another example, the interior core filling 11 is constructed to further have a predetermined amount of additive (such as AOE-9). Particularly, the interior core filling 11 is composed of 30-65% by weight of high strength cement, 1-5% by weight of EPS foam, 1-2.5% by weight of additive, 25-38% by weight of fly ash, and 15-40% by weight of water.

In another example, the interior core filling 11 is constructed to further have a predetermined amount of additive (such as AOE-9) and sand particles. Particularly, the interior core filling 11 is composed of 25-40% by weight of high strength cement, 0.5-1% by weight of EPS foam, 3-15% by weight of sand particles, 0.02-0.1% by weight of additive, 3-10% by weight of fly ash, and 25-40% by weight of water.

It is worth mentioning that the additive can be a foaming agent, i.e. AOE-9 (Polyoxyethylene lauryl ether-9), being mixed with the cement to produce cement foams with celluloses in honeycomb shape. The interior core filling 11 with the foam configuration can reduce the overall weight of the cement for forming a lightweight board structure, bind the celluloses in series to increase the strength of the interior core filling 11, and enhance the sound and thermal insulation due to the independent and close-structured cement foams.

Each of the exterior faces 12 is made of fiber reinforced material having properties of light weight, heat insulation, fireproof, and waterproof and moisture-proof. Preferably, each of the exterior faces 12 is made of fiber reinforced calcium silicate.

According to the preferred embodiment, the composite panel is constructed to have a side installation slot 13 and a side installation protrusion 14. The side installation slot 13 and the side installation protrusion 14 are formed at two opposed side edges of the composite panel, wherein the side installation protrusion 14 has a size and shape matching with a size and shape of the side installation slot 13.

Accordingly, the side installation slot 13 is formed by indenting the interior core filling 11 between the exterior faces 12, such that a predetermined amount of interior core filling 11 is removed from one side edge of the composite panel. Likewise, the side installation protrusion 14 is formed by protruding the interior core filling 11 between the exterior faces 12, such that a predetermined amount of interior core filling 11 is added into another side edge of the composite panel. Preferably, the side installation slot 13 has a rectangular or trapezoid cross sectional configuration defining a flat indented surface, wherein the side installation protrusion 14 has a rectangular or trapezoid cross sectional configuration defining a flat protrusion surface matching with the flat indented surface of the side installation slot 13. Therefore, when two solid cement construction panels 10 are coupled side-by-side, the side installation protrusion 14 of one of the solid cement construction panels 10 is engaged with the side installation slot 13 of another solid cement construction panel 10, so as to align the solid cement construction panels 10 with each other, as shown in FIG. 2. Preferably, a width of the side installation protrusion 14 is smaller than a thickness of the interior core filling 11. In other words, a width of the side installation slot 13 is also smaller than the thickness of the interior core filling 11.

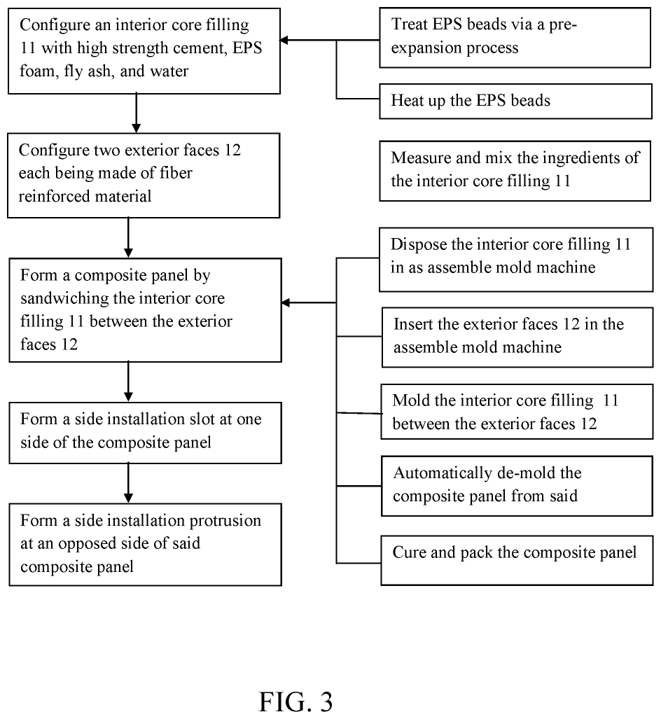

As shown in FIG. 3, the present invention further provides a method of manufacturing a solid cement construction panel, comprising the following steps.

(1) Configure the interior core filling 11 to have the high strength cement, EPS (expanded polystyrene) foam, fly ash, sand particles and water.

(2) Configure two exterior faces 12 each being made of fiber reinforced material.

(3) Form the composite panel by sandwiching the interior core filling 11 between the exterior faces 12.

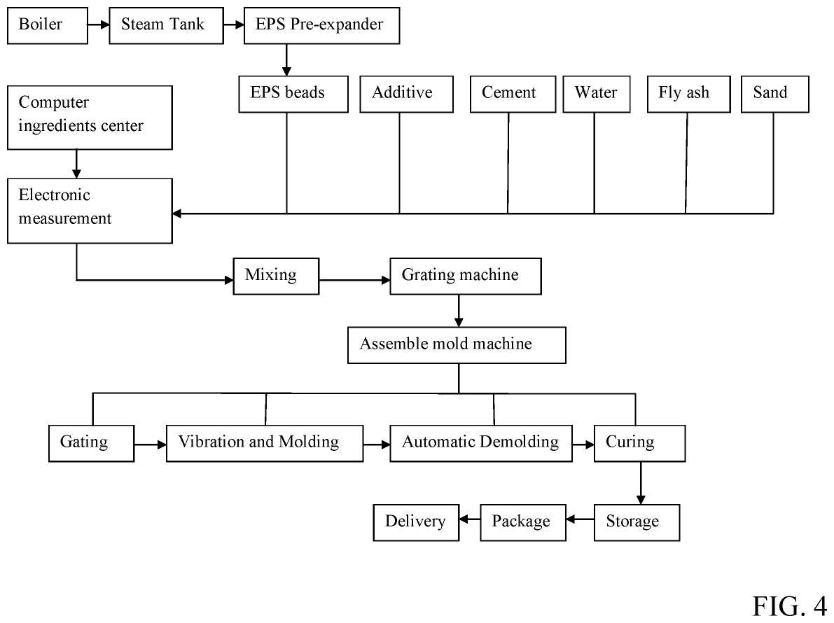

As shown in FIG. 4, the EPS foam is made by EPS beads or granules. wherein the EPS beads are impregnated with a blowing agent, such as pentane gas, and are treated via a pre-expansion process by a EPS pre-expander. Accordingly, the EPS beads are heated by via a boiler and a steam tank to expand a size of each of the EPS beads to form a plurality of individual foam pellets.

The ingredients of the interior core filling 11, such as the high strength cement, EPS (expanded polystyrene) foam, fly ash, sand particles and water, are separated and stored in individual compartments respectively. The ingredients of the interior core filling 11 are accurately measured by a computer ingredients center via electronic measurement to dispense from their corresponding compartments to a grating machine, such that the ingredients are mixed in the grating machine. Then, the mixture of the ingredients is delivered to dispose in an assemble mold machine. After the exterior faces are spacedly inserted into the assemble mold machine, the mixture of the ingredients is treated with grating process and vibration and molding process to integrally mold the interior core filling 11 between the exterior faces to form the composite panel. Then, the composite panel is treated with automatic demolding process from said assemble mold machine and curing the composite panel. Therefore, the solid cement construction panel 10 is formed to be stored, packaged and delivered.

In order to install the solid cement construction panel 10, a worker is able to measure an installation space for the solid cement construction panel to be installed, wherein the solid cement construction panel 10 is cut to fit the installation space. Then, mortar is prepared in pulpous state and is applied to a perimeter of the solid cement construction panel. The solid cement construction panel 10 can be erected vertically, wherein wood wedges can be used for temporarily fixing the solid cement construction panel in place. When a subsequent solid cement construction panels 10 is coupled to a previous one side-by-side, the subsequent solid cement construction panels 10 is pushed to have an engagement between the side installation slot 13 and the side installation protrusion 14. At the same time, excess mortar can be squeezed out and scraped away. After the solid cement construction panels 10 are preliminary installed, a wall surface alignment of the solid cement construction panels 10 is calibrated via a rectilinear scale check level to ensure the solid cement construction panels 10 being aligned with each other. Then, the worker can process the grouting operation to fill the gaps of the solid cement construction panels 10 with slurry and to remove the wood wedge from the solid cement construction panels 10. Preferably, a crack-resistant material is applied to the connections between the solid cement construction panels 10 once the slurry is dried. In order to install a junction box to the solid cement construction panel 10, the worker is able to cut the solid cement construction panel 10, such that the junction box can be implanted in the solid cement construction panel 10. Finally, plaster and/or paint can be applied to the solid cement construction panels 10 to complete the installation thereof.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A solid cement construction panel, comprising:
an interior core filling which is constructed to have a high strength cement, EPS (expanded polystyrene) foam, fly ash, and water, wherein said interior core filling has properties of heat preservation and soundproof; and
two exterior faces sandwiching said interior core filling therebetween to form a composite panel, wherein each of said exterior faces is made of fiber reinforced material having properties of light weight, heat insulation, fireproof, and waterproof and moisture-proof.

2. The solid cement construction panel, as recited in claim 1, wherein each of said exterior faces is made of fiber reinforced calcium silicate.

3. The solid cement construction panel, as recited in claim 1, wherein said interior core filling is composed of 5-18% by weight of high strength cement, 11-25% by weight of EPS foam, 1-10% by weight of magnesium oxysulfate cement, 0.02-1% by weight of additive, 5-28% by weight of sand particles, 15-40% by weight of fine rock particles, 3-20% by weight of fly ash, and 10-25% by weight of water.

4. The solid cement construction panel, as recited in claim 1, wherein said interior core filling is composed of 3-15% by weight of high strength cement, 10-25% by weight of EPS foam, 3-20% by weight of magnesium oxysulfate cement, 0.02-0.1% by weight of additive, 3-20% by weight of sand particles, 3-18% by weight of fine rock particles, 8-10% by weight of fly ash, 15-16% by weight of water, 0.5-1% by weight of polycarboxylate superplasticizer, 10-30% by weight of perlite concrete, and 5-15% by weight of fiberglass.

5. The solid cement construction panel, as recited in claim 1, wherein said interior core filling is composed of 30-65% by weight of high strength cement, 1-5% by weight of EPS foam, 1-2.5% by weight of additive, 25-38% by weight of fly ash, and 15-40% by weight of water.

6. The solid cement construction panel, as recited in claim 1, wherein said interior core filling is composed of 25-40% by weight of high strength cement, 0.5-1% by weight of EPS foam, 3-15% by weight of sand particles, 0.02-0.1% by weight of additive, 3-10% by weight of fly ash, and 25-40% by weight of water.

7. The solid cement construction panel, as recited in claim 1, wherein said high strength cement has a compression strength not lower than 42.5 MPa.

8. The solid cement construction panel, as recited in claim 1, wherein said composite panel has a side installation slot indented at said interior core filling between said exterior faces, and a side installation protrusion protruded from said interior core filling between said exterior faces, wherein said side installation protrusion has a size and shape matching with a size and shape of said side installation slot.

9. The solid cement construction panel, as recited in claim 1, wherein said interior core filling is integrally molded between said exterior faces to form said composite panel.

10. A method of manufacturing a solid cement construction panel, comprising the steps of:
(a) configuring an interior core filling by high strength cement, EPS (expanded polystyrene) foam, fly ash, and water;
(b) configuring two exterior faces each being made of fiber reinforced material;
(c) forming a composite panel by sandwiching said interior core filling between said exterior faces.

11. The method as recited in claim 10 wherein, in the step (b), each of said exterior faces is made of fiber reinforced calcium silicate.

12. The method as recited in claim 10 wherein, in the step (a), said interior core filling is composed of 5-18% by weight of high strength cement, 11-25% by weight of EPS foam, 1-10% by weight of magnesium oxysulfate cement, 0.02-1% by weight of additive, 5-28% by weight of sand particles, 15-40% by weight of fine rock particles, 3-20% by weight of fly ash, and 10-25% by weight of water.

13. The method as recited in claim 10 wherein, in the step (a), said interior core filling is composed of 3-15% by weight of high strength cement, 10-25% by weight of EPS foam, 3-20% by weight of magnesium oxysulfate cement, 0.02-0.1% by weight of additive, 3-20% by weight of sand particles, 3-18% by weight of fine rock particles, 8-10% by weight of fly ash, 15-16% by weight of water, 0.5-1% by weight of polycarboxylate superplasticizer, 10-30% by weight of perlite concrete, and 5-15% by weight of fiberglass.

14. The method as recited in claim 10 wherein, in the step (a), said interior core filling is composed of 30-65% by weight of high strength cement, 1-5% by weight of EPS foam, 1-2.5% by weight of additive, 25-38% by weight of fly ash, and 15-40% by weight of water.

15. The method as recited in claim 10 wherein, in the step (a), said interior core filling is composed of 25-40% by weight of high strength cement, 0.5-1% by weight of EPS foam, 3-15% by weight of sand particles, 0.02-0.1% by weight of additive, 3-10% by weight of fly ash, and 25-40% by weight of water.

16. The method, as recited in claim 10, wherein said high strength cement has a compression strength not lower than 42.5 MPa.

17. The method, as recited in claim 10, further comprising the steps of:
(d) forming a side installation slot at one side of said composite panel by indenting said interior core filling between said exterior faces; and
(e) forming a side installation protrusion at an opposed side of said composite panel by protruding said interior core filling between said exterior faces, wherein said side installation protrusion has a size and shape matching with a size and shape of said side installation slot.

18. The method as recited in claim 10 wherein, in the step (a), said EPS foam is made by the steps of:
treating EPS beads via a pre-expansion process; and
heating up said EPS beads to expand a size of each of said EPS beads to form a plurality of individual foam pellets.

19. The method, as recited in claim 10, wherein the step (c) comprises the steps of:
(c.1) measuring and mixing said high strength cement, said EPS foam, said fly ash, said sand particles and said water in a gating machine;
(c.2) disposing a mixture of said high strength cement, said EPS foam, said fly ash, said sand particles and said water in an assemble mold machine;
(c.3) inserting said exterior faces in said assemble mold machine; and
(c.4) molding said interior core filling between said exterior faces in said assemble mold machine to form said composite panel.

20. The method, as recited in claim 19, wherein the step (c) comprises the steps of:
(c.5) automatically demolding said composite panel from said assemble mold machine; and
(c.6) curing and packing said composite panel.
